(19) United States
(12) Patent Application Publication
(10) Pub. No.: US 2015/0210127 A1
(43) Pub. Date: Jul. 30, 2015

(54) Self-Inflating Inner Tube with A Non-Elastic Perimeter Band for a Tire

(71) Applicant: PumpTire AG, Geneve (CH)

(72) Inventor: Benjamin J. Krempel, Geneve (CH)

(21) Appl. No.: 14/414,007

(22) PCT Filed: Jul. 14, 2013
(86) PCT No.: PCT/IB2013/002608

§ 371 Date: Jan. 9, 2015

Related U.S. Application Data
(60) Provisional application No. 61/671,689, filed on Jul. 14, 2012.

(51) Int. Cl. B60C 23/12; B60C 5/08

(52) U.S. Cl. CPC B60C 23/12; B60C 5/08

(57) ABSTRACT

A self-inflating inner tube with a non-elastic band that encircles the defining perimeter of the inner tube. The band limits the expansion of the inner tube within the tire-rim chamber and creates a low pressure zone along the length of the chamber where a pumping mechanism is placed. As the wheel rotates the pumping mechanism collapses between the inner tube and tire thereby pushing air along its length. The compressed air is used to inflate the inner tube and maintain proper tire pressure.

### FIELD OF THE INVENTION

The invention relates to self-inflating inner tubes for tires.

### BACKGROUND OF THE INVENTION

There is considerable interest in developing a self-inflating inner tube, which is the focus of the present invention. Pneumatic tires require periodic refilling due to changes of temperature, diffusion of air through the rubber materials and air leaks within the system. Previous designs for self-inflating tires have shortcomings. For example some prior designs have a pumping mechanism located in just one area of the circumference of the wheel. This leads to bumpy or inconsistent riding characteristics. In other prior designs a self-inflating mechanism is incorporated directly into the tire. This may be advantageous for automotive applications where inner tubes are not commonly used, but prohibits its use in applications that use inner tubes such as bicycles. Other designs compress the pumping mechanism directly against a surface of the rim which leads to excessive wear and low ride quality. The present invention addresses at least one or more of these problems by providing a self-pumping (inflating) inner tube.

### SUMMARY OF THE INVENTION

A self-inflating inner tube for a tire is provided. The inner tube is an enclosed inflatable tube and defines a circumference, a medial side as an inner boundary and a lateral side as a perimeter. The inner tube includes various elements, which together create the self-inflating mechanism for the inner tube.

A valve stem is positioned at the medial side of the inner tube and is adapted to fit through a hole of a rim of a wheel. A first air inlet is located at the lateral side of the inner tube. A second air inlet is also located at the lateral side of the inner tube. The first and second air inlet are pneumatically separated from each other along the circumference of the inner tube. An air passage tube is present to pneumatically connect the valve stem and the first air inlet. The valve stem is further adapted with a first airway and a second airway. The first airway allows for air flow with the inner tube. The second airway is connected to the air passage tube allowing for air flow via the air passage tube. The valve stem could further have a air pressure control mechanism.

A first perimeter band circumferences the lateral side of the inner tube. The first perimeter band is non-elastic defined as to constrain expansion of the inner tube and is for example made out of kevlar, aramid, nylon, fiberglass, plastic or a combination thereof. In another example, the first perimeter band is made out of woven or non-woven materials. The first perimeter band, in yet another example, is made out of a material with fibers which are oriented lengthwise in the direction of said circumference. Non-elastic in one exemplary embodiment could also be defined by having a material where the stretching of the defining circumference is less than 4 mm in diameter with an inner tube pressure of 4 bar. Non-elastic in another exemplary embodiment could be defined by having a material, where the stretching of the defining circumference is less than 12 mm in diameter with an inner tube pressure of 5 bar (e.g. with a base circumference of 2160 mm).

A second perimeter band is included to act as a pumping mechanism and circumferences laterally from the first perimeter band. The second perimeter band is deformable during a force applied to the inner tube (e.g. during riding the bicycle). The second perimeter band could be made out of synthetic rubber, natural rubber, neoprene, silicone rubber, silicone or any combination thereof.

The first and second perimeter bands are positioned and aligned at a bottom-center of the inner tube. In one variation, the second perimeter band is adapted to snap inside a tire. For example, the tire for the inner tube could have latches to hold the second perimeter band in place.

The second perimeter band has one or more lumens through/inside and circumferencing the second perimeter band. The one or more lumens of the second perimeter band have:
(i) a pneumatic connection with the first air inlet, through the first perimeter band, for allowing air flow from outside the inner tube, though the second airway of the valve stem, and through the air passage tube into the one or more lumens, and
(ii) a pneumatic connection with the second air inlet for allowing air into the inner tube from the one or more lumens.

In one example, the first air inlet is positioned closer to the valve stem than the second air inlet.

One of the advantages of embodiments of the invention over previous designs is that the design creates no noticeable bump while riding. The pumping mechanism of the second perimeter band completely encircles the perimeter of the inner tube so there is no change in ride for the user. Another advantage is that the invention does not significantly alter ride quality due to the light weight and the small cross sectional area of the first and second perimeter bands. Aramid woven material can be used for the first perimeter band to constrain the inner tube. In one embodiment the internal cross sectional area of the lumen is an ellipse which measured 2 mm in height and 3 mm in width.

Assuming an average tire width of 30-35 mm, the lumen would occupy only about 1/10^{th} of the width of the tire.

### BRIEF DESCRIPTION OF THE DRAWINGS

### NUMERAL REFERENCES

110—Inner tube
120—Rim
130—Valve stem
140—Tire
142—Tire tread
144—Fitted Space for Second Perimeter Band 180 inside Tire 140
150—First Air inlet
152—Lateral Aspect of First Air Inlet 150 through First Perimeter Band 170 connecting to Lumen(s) 182 through Pumping Mechanism 180
160—Second Air Inlet
162—Lateral Aspect of Second Air Inlet 160 through First Perimeter Band 170 connecting to Lumen(s) 182 through Pumping Mechanism 180
170—First Perimeter (Non-Elastic) Band
180—Second Perimeter Band (Pumping Mechanism)
182—Lumen through Pumping Mechanism 180
190—Air Passage Tube

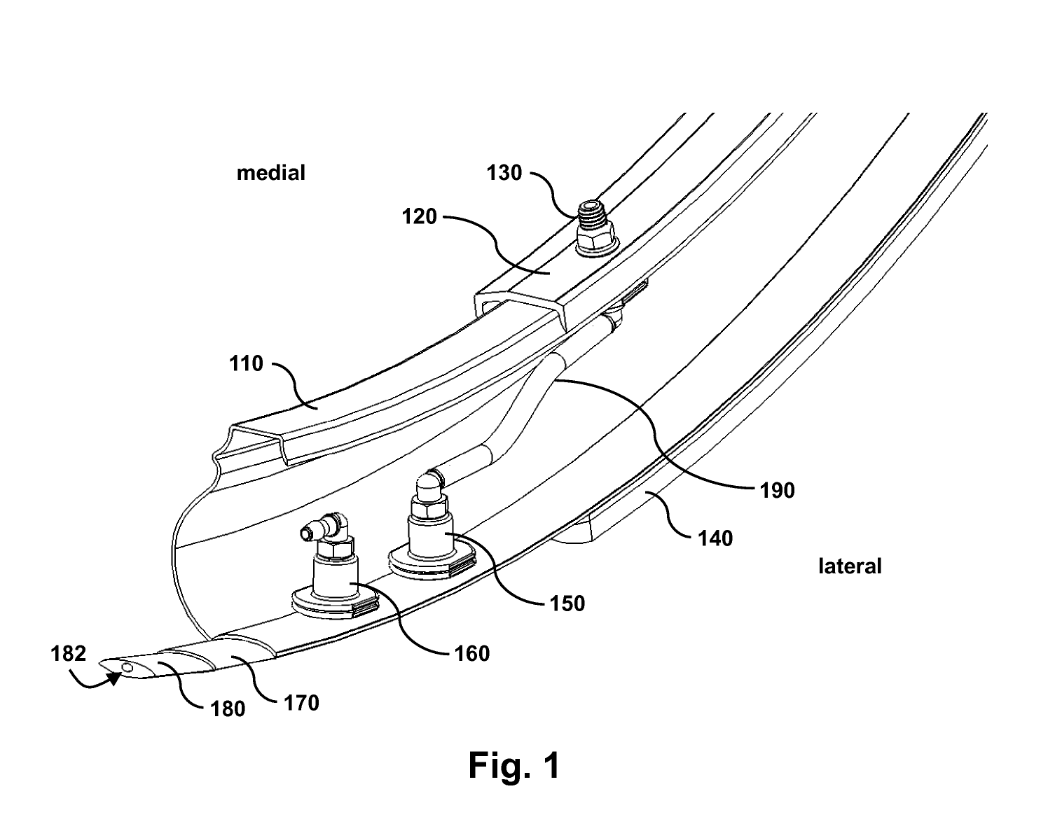

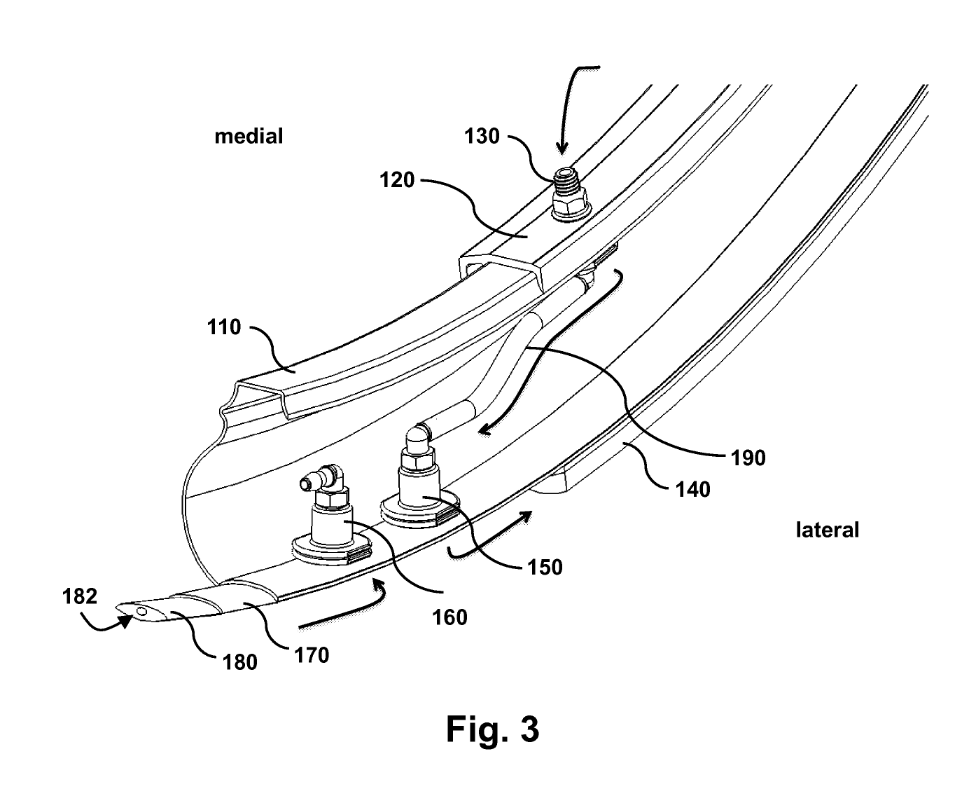

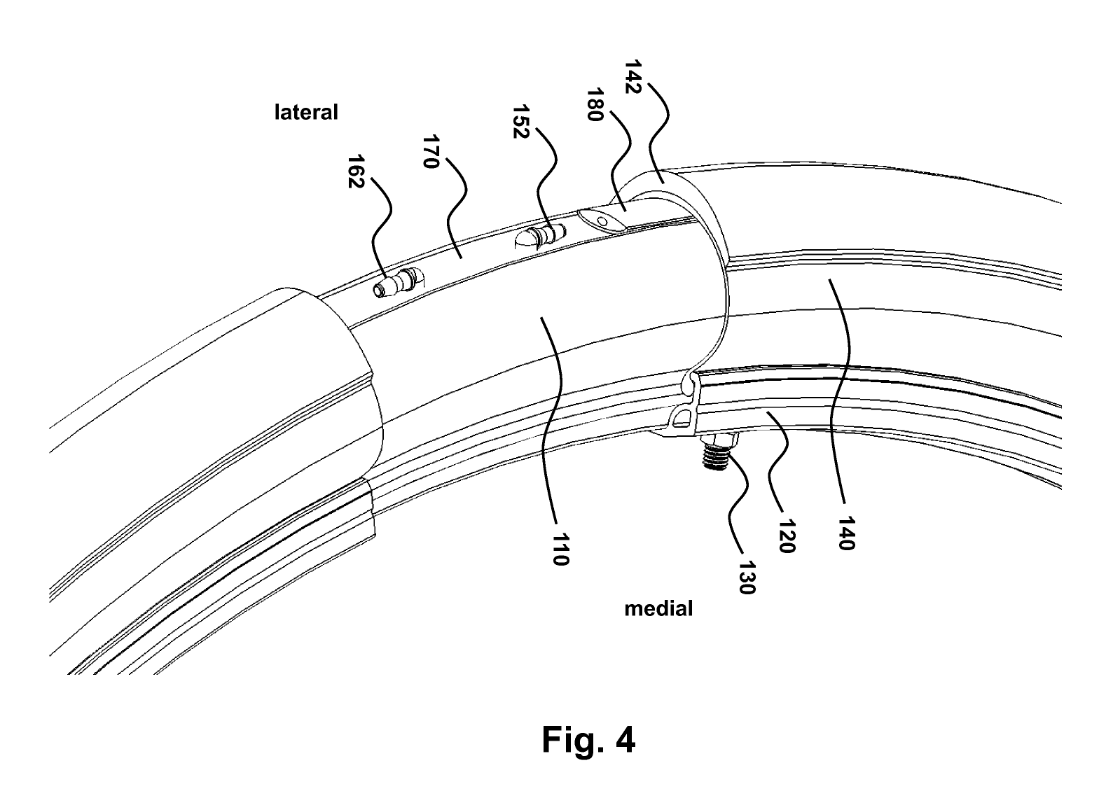

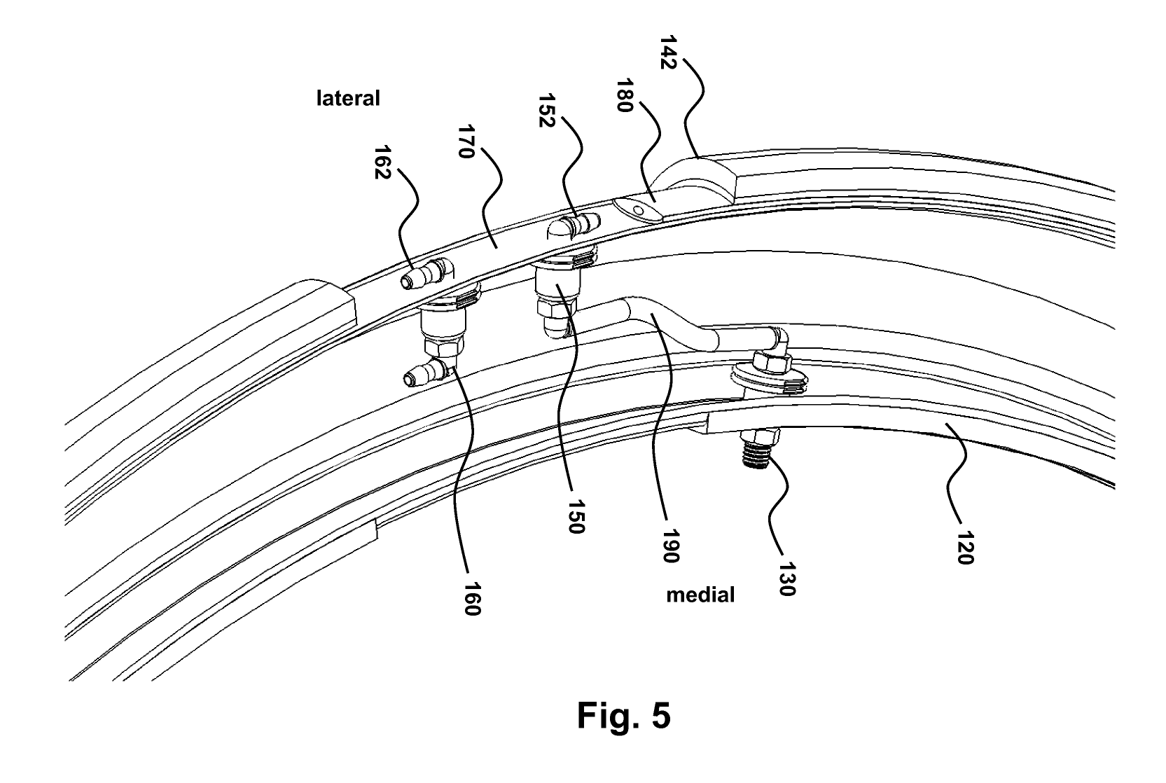

FIGS. 1, 3-5 show self-inflating inner tubes integrated with a rim and tire according to exemplary embodiments of the invention.

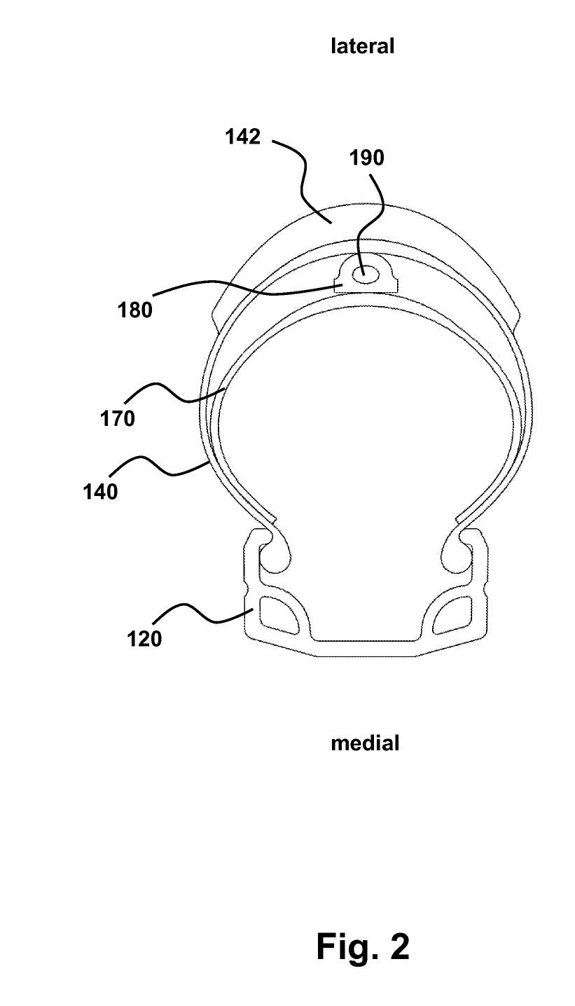

FIGS. 2, 6-7 show cross-section of a self-inflating inner tube integrated with a rim and tire according to exemplary embodiments of the invention.

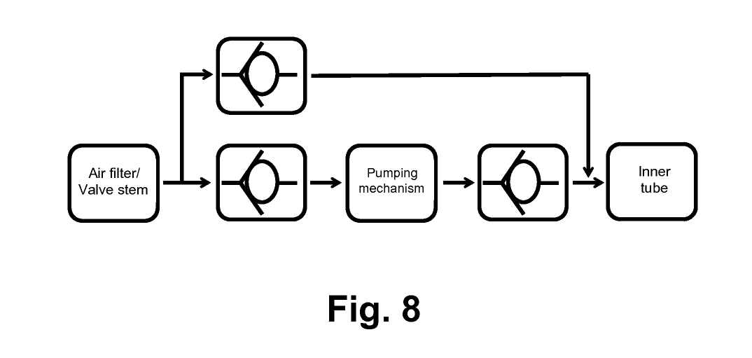

FIG. 8 shows a flow diagram of the working mechanism of a self-inflating inner tube according to an exemplary embodiment of the invention. The diagram shows three one-way valves.

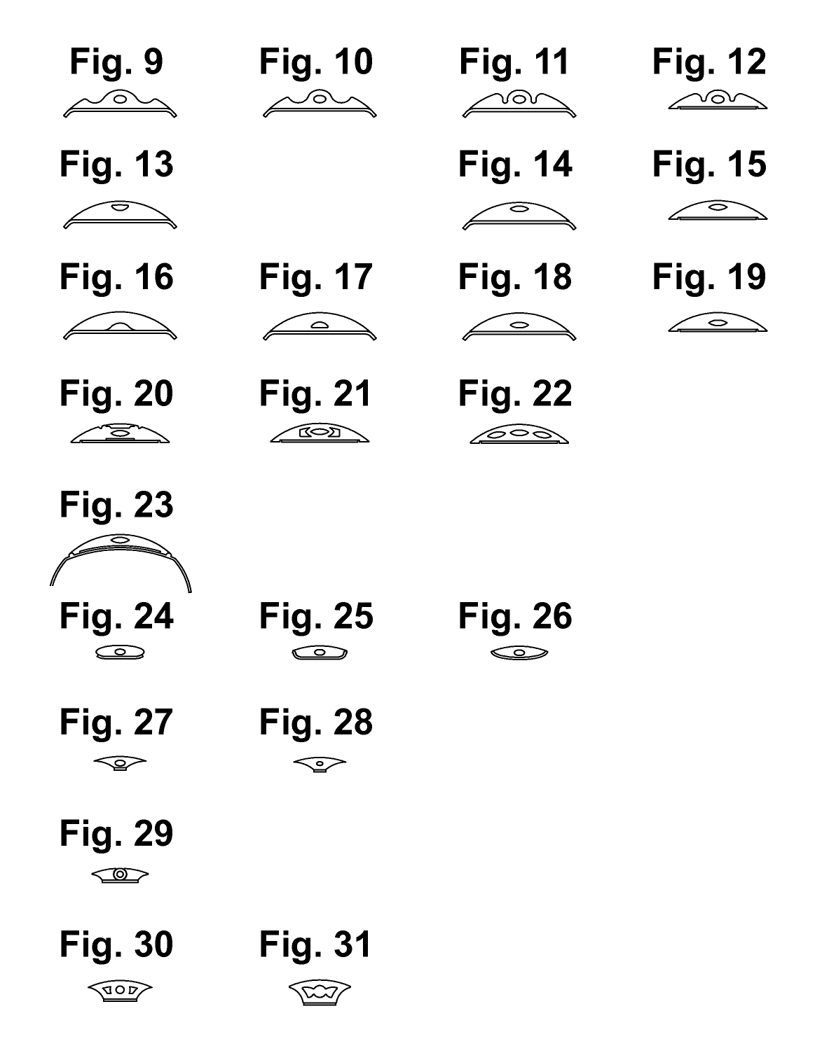

FIGS. 9-31 show variations of designs of the pumping mechanism of the second perimeter band according to exemplary embodiments of the invention.

### DETAILED DESCRIPTION

First Perimeter (Non-Elastic) Band

The self-inflating inner tube of this invention employs a first perimeter band which is a non-elastic band around the perimeter of the defining circle of the inner tube. The first perimeter band stops the inner tube from expanding completely within the tire-rim chamber thereby creating a low-pressure zone within the tire-rim chamber. In one embodiment a single first perimeter band is positioned bottom dead center (BDC) where the tire contacts the riding surface. In another embodiment there are more than one non-elastic first perimeter bands which work together to create the low-pressure zone.

The low-pressure zone is located outside the first perimeter band and inside the tire. In this low-pressure zone a second perimeter band referred to as a pumping mechanism is placed. The second perimeter band is situated around the perimeter of the defining circle of the inner tube in between the first perimeter band and the tire as shown in the figures.

The first and second perimeter bands can be permanently attached to the tire or releasably attached to the tire. The first and second perimeter bands can be permanently attached to the inner tube or releasably attached to the inner tube. When the first and second perimeter bands are attached to the inner tube, the frictional force of the inner tube pressing against the tire may keep the bands properly positioned. Adhesives or other means may be applied to the inner tube and tire to keep the first and second perimeter bands properly positioned.

The first perimeter band may additionally have areas where it is wrapped around the inner tube in one or more regions, but the pumping effect is achieved by the second perimeter band wrapped around the defining circle of the inner tube. The first perimeter band diameter has the advantage of being user-adjustable to accommodate different sized tires. Tire size varies with model, brand and other variables. Even tires designed to accommodate the same rims may differ in size. For the pumping mechanism to work properly, the first perimeter band needs to be sized slightly smaller than the inner diameter of the tire. In one embodiment the first perimeter band incorporates a sizing mechanism similar to a pull tie which allows the embodiment to be used with multiple tires. The first perimeter band may be made of aramid, Kelvar, nylon, fiberglass, plastic or other material. The material may be woven or non-woven materials. The fibers may be oriented along the length of the perimeter at 0, 30, 45 or 90 degrees or at any other angle orientation. Fibers oriented at 0 degrees (i.e. lengthwise in direction of the circumference of the first perimeter band) has the advantage of single fibers being able to carry the load completely around the inner tube. The first perimeter band may also have a stiffening member to both stiffen and shape the pumping chamber. This will ensure force is applied to the pumping mechanism under low pressure and that the shape of the pumping mechanism opens and closes in the desired fashion.

Second Perimeter (Pumping Mechanism) Band

The pumping mechanism of the second perimeter band rides in a pocket between the inner tube and the tire, allowing the second perimeter band to change positions relative to the inner tube as the inner tube expands and contracts. As the wheel rolls the tire is deformed in the area of the contact patch. This collapses the second perimeter band pushing air along the length of the second perimeter band through one or more lumens through the circumference length of the second perimeter band. Once the load is removed from the section of tire, the second perimeter band returns to its original shape drawing in air for the next cycle. The spring force used to draw in air may come at least partially from the tire, the second perimeter band or any other part of the system.

In one embodiment the second perimeter band is made out of elastomeric materials which return back to their original shape after being compressed. The second perimeter band may be constructed at least partially of at least one of the following materials—synthetic rubber, natural rubber, butyl rubber, neoprene, silicone rubber, silicone, or any other rubber formulation. The spring force is provided, at least in part, by the shape, and the lumen. The pumping mechanism of the second perimeter band could be optimized by utilizing a number of different designs as shown in FIGS. 9-31. The shape of the lumen is guided by the performance requirements of the inner tube and tire. For example the wall thickness and material properties of the lumen influence both spring force and force required to collapse the pumping mechanism. Side air channels such as in design FIG. 21 or FIG. 22 can be employed to lower the force required to collapse the second perimeter band. In these designs the air channels do not push air into the inner tube, but rather may be sealed or unsealed to meet performance requirements. In another embodiment the side channels may be filled at least partially with materials which further benefit the pumping mechanism performance. The filling materials may be elastomeric, gel or any other material. The second perimeter band may be made of two or more materials designed in such a way to enhance the performance of the pumping mechanism. For example in FIG. 20 a harder durometer rubber may be used on the top and bottom of the second perimeter band to transfer force more efficiently from the contact patch to the second perimeter band and the surrounding material may be made of a softer durometer material to facilitate the collapse of the second perimeter band. In example FIG. 31 the second perimeter band is used in combination with separately manufactured inner tube which allows for multiple materials to be used with each other.

Alignment Cover

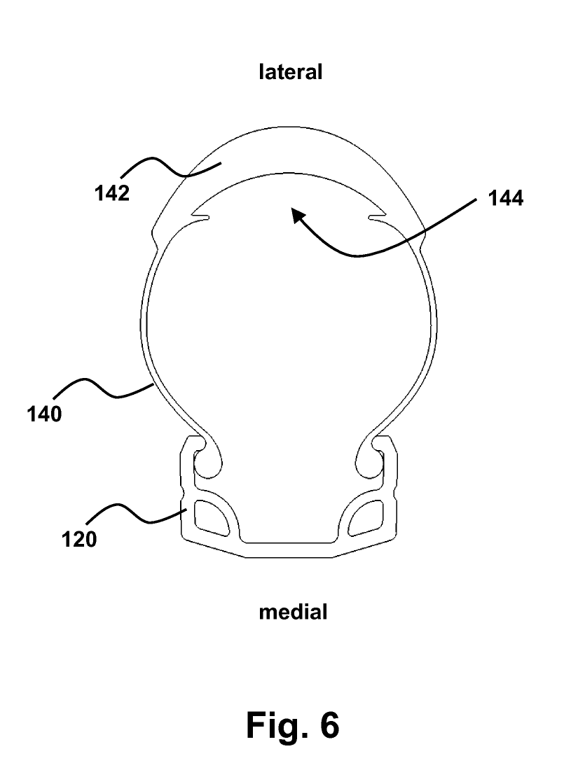

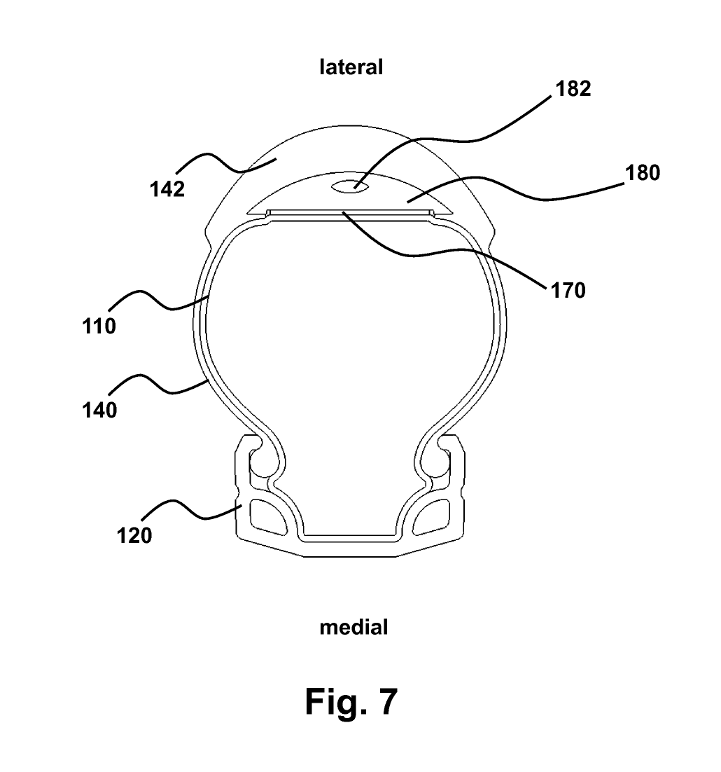

For the designs according to embodiments of the invention to work properly the first and second perimeter bands need to stay in the proper position bottom-dead-center on the inner tube. This can be accomplished in several ways. In one embodiment the second perimeter band is attached at least partially to the inner tube. This could be done with adhesives, rubber cement, vulcanization, removable tape, and friction-fit devices such as tabs, Velcro, snaps, hooks or any other known method. In another embodiment the second perimeter band could be located in a pocket created by the inner tube and another material (FIGS. 6-7). In this embodiment the first and second perimeter bands are able to float freely within the pocket along their length, but are closely restricted in their side to side movement. In yet another embodiment it might also be advantageous to join the first and second perimeter bands at least partially to the tire. This can be done with adhesives, rubber cement, vulcanization, removable tape, and friction-fit devices such as tabs, Velcro, snaps, hooks or any other known method. The adhesion method may run the entire length of the second perimeter band thereby completely encircling the tire or it may be applied in only one or more places. In still another embodiment the second perimeter band could be kept in place by tabs on the tire which create a friction fit with the inner tube as shown in FIG. 7. In still another embodiment the second perimeter band may be kept in place by features that orient the inner tube on the rim. This may include an elastic band that stretches to secure the inner tube the rim and then allows the rest of the inner tube to float in the tire cavity. The elastic band would work like a rubber band that stretches to hold the inner tube in place. In still another embodiment the features may be constructed at least partially of plastic materials that can be joined to secure the inner tube. In one example the plastic pieces snap together to secure the inner tube. In another example the plastic pieces adjustably snap together like pull ties to secure the inner tube.

Air Manifold System

One of the elements of the self-inflating inner tube is an air manifold system (also referred to as an air passage tube) that creates a passageway into the lumen of the second perimeter band. The air inlet to the lumen is on or near the valve stem and pneumatically connects to the lumen of the second perimeter band allowing air to enter the pumping mechanism. In the examples shown in the figures, the air passage tube runs through the inner tube although it could also be located outside the inner tube (the latter is not shown). The air inlet to the inner tube pneumatically connects the lumen of the second perimeter band to the inner tube allowing pressurized air to enter the inner tube. The air passage tube needs to withstand considerable pressure to avoid being compressed closed. The air passage tube may use an array of materials to avoid collapse. It may employ rubber, reinforced rubber, natural rubber, latex rubber, pvc, plastic, polyurethane, polyethylene, metal, steel, glues, steel coil springs or any other commonly used reinforcement material. It may connect the valve stem and lumen of the second perimeter band by an elongated pathway or a pathway with bends to create a stress relief area to optimize ride quality of the tire.

Control System Within the Inner Tube

When the inner tube is pumping, filtered air flows into the valve stem and is carried by the air passage tube to the air inlet to the lumen. The air then enters the lumen. Once in the lumen the air travels the length of the second perimeter band. At the end of the second perimeter band the air passes through the air inlet to the inner tube, thereby entering the inner tube. There is a first one-way valve before the entrance of the lumen that stops the air from flowing backwards through the system. The first one-way valve may be located in the valve stem, in the air passage tube, in the air inlet to the lumen or in the beginning of the lumen. A second one-way valve is located at the end of the lumen near the air inlet to the inner tube.

The air inlet to the lumen pneumatically connects the air passage tube to the lumen of the second perimeter band.

The air inlet to the inner tube pneumatically connects the lumen to the inner tube.

The valve stem performs three primary functions. It pneumatically connects the pressure control system to the air passage tube. It pneumatically connects the pressure control system to the inner tube. And it serves as a mounting point to physically connect the pressure control system to the self-inflating inner tube. The pressure control system is releasably attached to the valve stem. The valve stem may contain the first one-way valve to regulate the flow of air into the air passage tube. The valve stem comprises a third one-way valve that allows air to be pumped directly into the inner by conventional air pumping methods.

### EXAMPLE

In one example design, we used a custom manufactured (second perimeter band) pumping mechanism made from neoprene with durometer of shore A 60 and extruded by VIP Rubber located in La Habra, Calif. The second perimeter band is adhered to the first perimeter band using black neoprene cement manufactured by McNett Corp in WA, USA. The first perimeter band is nylon-reinforced rubber (non-elastic). The first perimeter band has a circumference of 2160 mm. Two 4 mm holes are die cut into the first perimeter band. The holes are placed 50 mm apart and correspond to the air entry and exit locations on the second perimeter band. This assembly is then attached to a Schwalbe SV17 inner tube that has been modified by adding two additional fittings and the internal air passageway to bring air from the valve stem to the air inlet of the first perimeter band. The inner tube connects to the air inlet of the second perimeter band with threaded nylon elbow fittings with a 3/32^{nd} barb that fits into the second perimeter band. The connection is then secured using nylon pull ties. When completed, air enters the system through the valve stem, passes through the inner tube and first perimeter band and into the lumen of the second perimeter band. When the system is pumping, air enters the lumen of the second perimeter band and is pushed around the circumference of the tire before exiting into the inner tube. The system uses two check valves to direct the flow of air into the system. The first is a F-2804-404 check valve manufactured by Air Logic in WI, USA which is attached to the valve stem. The second is placed inside the inner tube and is constructed from thin film PVC which has been heat welded together.

The self-inflating mechanism according to examples of this invention can be engineered to achieve a variety of different performance specifications. For example, systems for kids would benefit from being able to pump under very low rider weight, i.e., less than 25 kg. Systems for road cycling would benefit by being able to pump pressures above 8 bar. These systems can be engineered with an understanding of the variables that influence performance. For example, second perimeter bands with larger diameter lumen are capable of pumping more air with each rotation. They are also, however, limit the pressures they can be generated during each cycle. If the lumen diameter is reduced, more load can be concentrated onto a smaller area making it possible to generate the higher pressures. The materials directly above and below the lumen may also have increased stiffness to transfer load from the surrounding materials and further concentrate load on the lumen. The increased stiffness, may, however, contribute to increased rolling resistance. This effect has to be balanced with the stiffness of the second perimeter band on the horizontal plane. The horizontal plane is parallel to the ground when the bicycle is being ridden. The material on the horizontal plane is responsible for the generating the spring force that is required to drawn in air for each pumping cycle. Another possibility for generating higher pressures is to employ multiple check valves in the second perimeter band. This would allow the system to act in some ways as a multi-stage pump. Air would be compressed and stored at different pressures in the lumen. As the wheel rotates the pressure in each stage would go up and it would not require each stage to start at atmospheric pressure for each rotation.

What is claimed is:

1. A self-inflating inner tube for a tire, comprising:
(a) an inner tube, wherein said inner tube is an enclosed inflatable tube defining a circumference, a medial side as an inner boundary and a lateral side as a perimeter, wherein said inner tube comprises:
(i) a valve stem positioned at said medial side and adapted to fit through a hole of a rim of a wheel;
(ii) a first air inlet located at said lateral side, and
(iii) a second air inlet located at said lateral side, wherein said first and said second air inlet are pneumatically separated from each other along said circumference of said inner tube; and
(iv) an air passage tube pneumatically connecting said valve stem and said first air inlet, wherein said valve stem is further adapted to having a first airway and a second airway, wherein said first airway allows for air flow with said inner tube, and wherein said second airway is connected to said air passage tube allowing for air flow via said air passage tube;
(b) a first perimeter band circumferencing said lateral side of said inner tube, wherein said first perimeter band is non-elastic to constrain expansion of said inner tube;
(c) a second perimeter band to act as a pumping mechanism circumferencing said first perimeter band, wherein said second perimeter band is deformable during force applied to said inner tube, wherein at least aspects of said first and second perimeter bands are aligned along said circumference, and wherein said second perimeter band has one or more lumens inside and circumferencing through said second perimeter band;
wherein said one or more lumens of said second perimeter band have:
(j) a pneumatic connection with said first air inlet, through said first perimeter band, for allowing air flow from outside said inner tube, though said second airway of said valve stem, and through said air passage tube into said one or more lumens, and
(jj) a pneumatic connection with said second air inlet for allowing air into said inner tube from said one or more lumens,
therewith creating a self-inflating mechanism for said inner tube.

2. The self-inflating inner tube as set forth in claim 1, wherein said first perimeter band is made out of kevlar, aramid, nylon, fiberglass, plastic or a combination thereof.

3. The self-inflating inner tube as set forth in claim 1, wherein said non-elastic is defined as a defining circumference of said first perimeter band stretching less than 4 mm in diameter with an inner tube pressure of 4 bar.

4. The self-inflating inner tube as set forth in claim 1, wherein said first perimeter band is made out of woven or non-woven materials.

5. The self-inflating inner tube as set forth in claim 1, wherein said first perimeter band is made out of a material with fibers which are oriented lengthwise in the direction of said circumference.

6. The self-inflating inner tube as set forth in claim 1, wherein said second perimeter band is made of synthetic rubber, natural rubber, neoprene, silicone rubber, silicone or any combination thereof.

7. The self-inflating inner tube as set forth in claim 1, wherein said valve stem further comprises an air pressure control mechanism.

8. The self-inflating inner tube as set forth in claim 1, wherein said second perimeter band is adapted to snap inside a tire.

9. The self-inflating inner tube as set forth in claim 1, wherein a tire for said inner tube has latches to hold said second perimeter band in place.

10. The self-inflating inner tube as set forth in claim 1, wherein said first and said second perimeter bands are positioned and aligned at a bottom-center of said inner tube.

11. The self-inflating inner tube as set forth in claim 1, whereby said first air inlet is positioned closer to said valve stem than said second air inlet.
